(19) United States
(12) Patent Application Publication
(10) Pub. No.: US 2002/0199013 A1
(43) Pub. Date: Dec. 26, 2002

(54) Method and apparatus for moving HTML/XML information into a HTTP header in a network

(76) Inventor: Lauge S. Sorensen, Hillerod (DK)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/887,070

(22) Filed: Jun. 25, 2001

(51) Int. Cl. G06F 15/16

(52) U.S. Cl. 709/236

(57) ABSTRACT

Method and apparatus for moving Hyper Text Markup Language (HTML) and Extensible Markup Language (XML) information into a Hyper Text Transfer Protocol (HTTP) header. HTML or XML content is created. Information is inserted into the content where all inserted information has identifiers. The content is searched for all information with the identifiers. A HTTP header is generated for the content where the generated HTTP header includes the information located in the content. The content may be created and the information inserted by a developer at a web server. The content is received at a network node that searches the content and creates the HTTP header incorporating the information. Other network nodes may use the information in the header, for example to control storage of the content at an Internet cache.

### BACKGROUND

1. Field of the Invention

This invention relates to network packets, and more specifically to incorporation of information in the content of a packet into the header of the packet.

2. Background Information

The use of networks, specifically the Internet and World Wide Web, is steadily increasing. Typically, a user sitting at a computing device (client) requests access to content that resides on a server. The server is generally located at a remote location from the user's computing device. The user gains access to the content on the server through the network, e.g., the Internet. Therefore, a request from a client must travel onto the network to the server where the content resides. The server replies by supplying the content across the network to the client. The content may pass through one or more other network nodes such as gateways, routers, switches, caches, accelerators, etc. in traveling from the server to the client. These network nodes look at headers associated with the content to determine if any actions need to be taken, e.g., where and how to route the content to the client.

Today, companies, organizations, and individuals are increasingly developing their own web pages that reside at servers accessible by clients. The developers of web pages typically have access to the document (i.e., content) only and are not involved in the generation of an associated header. A hyper text transfer protocol (HTTP) header is usually associated with content transferred across the Internet. The content may be in the form of hyper text markup language (HTML) or extensible markup language (XML). Network nodes, such as routers and Internet caches, only inspect the HTTP header for control and other information to determine how to handle the content. Network nodes such as these do not have time to look into actual content because of performance reasons.

An Internet cache, for example, inspects the HTTP header associated with content to determine how long to store the content. If the content relates to one or more web pages, each page may have an associated header that identifies how long the Internet cache should maintain each particular web page. For example, a corporate web page may be maintained by an Internet cache for an extensive amount of time since it may never or seldom change. However, content that contains news or other dynamic or time sensitive information may only be maintained by an Internet cache for a short period of time. A developer of the content is most familiar with what types of control or other information (e.g., Internet cache control information) should be associated with the content. However, since this information must reside in the HTTP header, and the developer generally does not have access or control over the creation of the HTTP header (only the content), a developer of content has no way to insert control or other information related to the content into the header for use by network devices/nodes. Therefore, there is a need for apparatus and methods for insertion of information resident in the content into an HTTP header for use by network nodes.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a system diagram including a network appliance according to an example embodiment of the present invention; and

FIG. 2 is a flowchart of an example process for moving HTML/XML information into a HTTP header in a network according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to method and apparatus for creating a HTTP header that includes information that resides in the content of a document. This allows the developer of the content to include control or other information related to the content in the content itself so that it may be subsequently moved into an associated HTTP header where it may be used by network nodes. It is advantageous to allow a developer of the content to specify control, handling or other content relevant information since the developer is the person knowing the content and, therefore, also knows how it should be controlled (e.g., cached).

Apparatus and methods according to the present information may be used in any network that has network nodes or devices that inspect a header on content received to make decisions regarding the content. This may include, for example, routing, displaying, storing, modifying, encryption, decryption, etc. of the content. Depending on the network, the format or method used to create the content may vary. Information that has been included in the content that the developer of the content desires to be moved or included in a header associated with the content may be identified in some form. Identifiers may be associated with the information such as, for example, meta tags, labels, tags, commands, etc. Methods and apparatus according to the present invention search the content for information with identifiers. This information is then incorporated into a header that may be created or modified and associated with the content. Therefore, when a network node receives the header and associated content, the control or other information that the developer desired to be used resides in the header whereby the network node may act on the content and/or header accordingly.

Methods and apparatus according to the present invention may also be versatile in that only information with certain identifiers may be incorporated into a header that is created or modified. Further, depending on network conditions such as, for example, network traffic, load balancing, network statistics, quality of service, service level agreements, etc., a network node according to the present invention may search content received for identifiers related to the network conditions and create a header only incorporating information with those identifiers. This is advantageous in that the creation/modification of a header according to the present invention may be dynamic based on current existing conditions. Currently, headers associated with content are created at servers regardless and independent of any network conditions.

Regarding the Internet, headers are generally HTTP headers. The content may be developed using HTML or XML. If the content is created using HTML, the identifiers used to identify information in the content that may be desired to be moved to a header for use by a network node, may be meta tags. Therefore, a developer of HTML content may use meta tags to identify information that the developer desires to be incorporated into a HTTP header so that it may be used by network nodes in the Internet. For XML content a variety of identifiers may be used by a developer to identify the information in the content. Further, identifiers other than meta tags for HTML content may be used and still be within the spirit and scope of the present invention.

To illustrate the present invention, the following is an example HTML meta tag that may reside in content:

<HEAD>

<META HTTP-EQUIV=“expires” CONTENT=“Thur, Jul 5, 2001 14:00:42 GMT>

</HEAD>

This meta tag is preceded by “<HEAD>” title and ends with the “</HEAD>”. This denotes that the meta tag is in a head section of the HTML document. This particular meta tag defines an expiration time of a document to utilize an automatic refresh in a client's browser.

Methods and apparatus according to the present invention may search the content for meta tags and then create or modify an HTTP header that includes the information identified by the meta tag. The following is an example HTTP header generated after identification of the information in the HTML content denoted by a meta tag:

HTTP/1.1 200 OK

Expires: Thur, Jul 5, 2001 14:00:42 GMT

Note that the content of the meta tag, i.e., the expiration time, is now in the HTTP header. This allows this information to be used by network nodes that receive the header and content as it travels across a network such as the Internet. Methods and apparatus according to the present invention may remove the information from the content once it is inserted into an HTTP header, or may simply replicate the information in the HTTP header and leave it in the content. For performance reasons, HTML meta tags may only be used by client browsers and not by Internet network nodes in general. This is true since browsers generally use content and have the time to look into content. Network nodes do not have this time and, therefore, generally only look into protocol headers such as an HTTP header, for information.

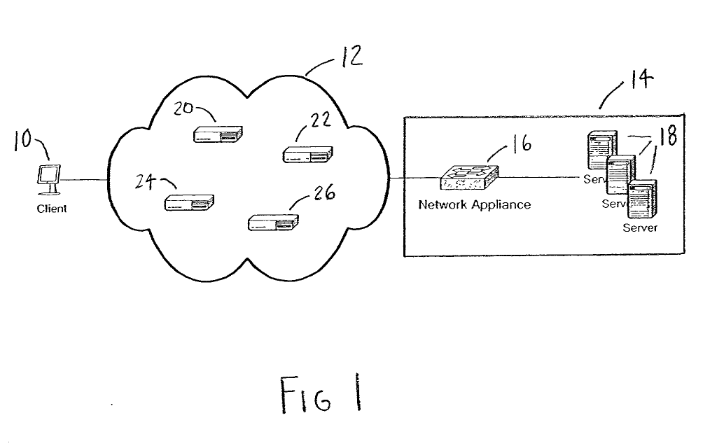

FIG. 1 shows a system diagram including a network appliance according to an example embodiment of the present invention. This figure shows the interconnection between a client 10 through the Internet 12 to a data center or enterprise 14. Data center 14 may include a network appliance 16 and one or more servers 18. Device 16 may be a network device (e.g., router) that includes a network appliance that incorporates the present invention. Network appliance 16 may be hardware, software, or a combination. Moreover, network appliance 16 may reside at data center 14 or on the network outside data center 14. The Internet may include several network nodes or devices 20-26. Network devices 20-26 may be any of several types of network devices, for example, routers, proxy servers, Internet caches, gateways, SSL accelerators, etc. Data center 14 may reside at a company whereby one of the servers 18 contain the corporate web page.

A developer may develop content (i.e., HTML or XML documents) at one or more of server 18. Server 18 may include applications that automatically generate headers for the content using a specific protocol (e.g., HTTP). As is noted previously, since the header may be generated at the server, a developer of content has no way of getting content specific control or other information into the HTTP header. A client desiring to access the corporate web page resident at server 18, submits a request through Internet 12 to data center 14 where it is received by server 18. Server 18 then responds by sending the appropriate web page or pages to network appliance 16. Network appliance 16 incorporates the present invention and searches the HTML or XML content for information with certain identifiers. Once located, this information is used to create or modify an HTTP header that is then attached to the content and forwarded through Internet 12. In traversing Internet 12, the content and associated HTTP header may traverse through one or more of Internet nodes 20-26. Internet nodes 20-26 may inspect the HTTP header to determine routing and other information or actions that may be required. Eventually, the web page including the content is supplied at client node 10.

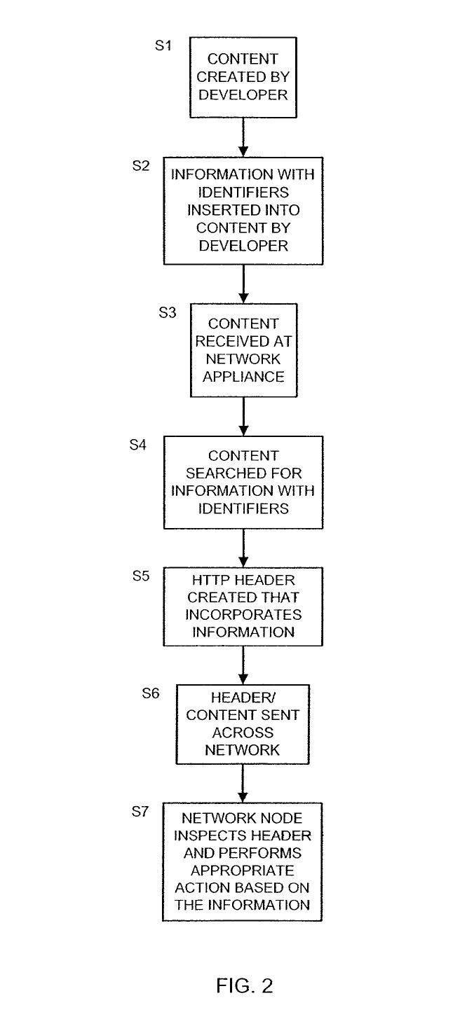

FIG. 2 shows a flowchart of an example process for moving HTML/XML information into a HTTP header in a network according to an example embodiment of the present invention. Content is created by a developer S1. This content may be HTML or XML content. The developer inserts information into the content with associated identifiers S2. The content is received at a network appliance S3. The content is searched to locate information with identifiers S4. An HTTP header is created or modified that includes the information found in the content S5. The HTTP header and content are sent across the network (e.g., Internet) S6. A network node inspects the HTTP header and performs an appropriate action S7.

To further illustrate the present invention, we assume that one of the Internet nodes, i.e., 20, is an Internet cache. A developer at data center 14 develops the HTML or XML content and incorporates Internet cache control information into the content. The content may relate to one or more web pages where each web page is a separate document, i.e., content, with its own header. Each document may require its own unique handling at an Internet cache. The developer associates the Internet cache control information in the content with an identifier. This identifier may be a meta tag.

The content may be received at a network appliance 16 and then the content searched for information with identifiers, i.e., meta tags. The information defined with identifiers may be used to generate or modify an HTTP header associated with each content/document. The information defined by the meta tags is now incorporated into the header and this header along with the content sent across Internet 12. An Internet cache 20 may then receive the header and content and inspect the header. The Internet cache control information now contained in the header may be used to determine how long to store the particular content associated with the header. Caching helps Internet users (e.g., clients) to load web pages faster and, therefore, reduce Internet link bandwidth and web server load in electronic business (e-business) data centers. Therefore, controlling caching in the Internet is essential to reduce latency and to improve efficiency of data centers. An Internet cache has been used here for the purposes of illustrating the present invention. However, network nodes 20-26 may be any type of device as mentioned previously and still be within the spirit and scope of the present invention.

Methods and apparatus according to the present invention are advantageous for a number of reasons. These include the ability to dynamically create HTML or XML document content based HTTP header information (e.g., Internet caching information). Further, the present invention allows the ability to dynamically create HTTP header information based on network traffic (e.g., traffic monitoring, network statistics, quality of service, service level agreements (SLA), etc.). Moreover, the present invention allows the ability to create HTTP header information in a uniform way independent of web server applications. Further, this allows the ability to add HTTP header creation control that might otherwise not be provided by a web application.

It is noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for moving Hyper Text Markup Language (HTML) and Extensible Markup Language (XML) information into a Hyper Text Transfer Protocol (HTTP) header comprising:
creating one of HTML and XML content;
inserting information into the content, all inserted information having identifiers;
searching the content for all information with the identifiers; and
generating a HTTP header for the content, the generated HTTP header including the information located in the content.

2. The method according to claim 1, further comprising performing the creating and inserting by a developer at a network device.

3. The method according to claim 2, wherein the network device is a web server.

4. The method according to claim 1, wherein the content comprises at least one web page.

5. The method according to claim 1, wherein the information comprises Internet cache control information.

6. The method according to claim 1, wherein the identifiers comprise at least one of a Meta tag, a label, a tag, and a command.

7. The method according to claim 1, performing the searching and generating at a network node, the network node being at a different location than where the creating and inserting are performed.

8. The method according to claim 7, wherein the network node comprises a router.

9. The method according to claim 8, further comprising performing the searching and generating by a network appliance at the router.

10. A device connected to a network comprising:
an interface to at least one network device, the interface receiving one of HTML and XML content, the content having information inserted into it, all inserted information having identifiers;
a network appliance, the network appliance searching the content for all information with the identifiers and generating a HTTP header for the content, the generated HTTP header including the information located in the content; and
a second interface to a network, the HTTP header and associated content being sent to across the second interface to at least one network node.

11. The device according to claim 10, wherein the at least on network device comprises a server.

12. The device according to claim 10, wherein the information comprises Internet cache control information.

13. The device according to claim 10, wherein the identifiers comprise at least one of a Meta tag, label, tag, and a command.

14. The device according to claim 10, wherein the network comprises the Internet.

15. The device according to claim 10, wherein the at least one network node comprises an Internet cache.

16. The device according to claim 10, wherein the content comprises at least one web page.

17. An apparatus comprising a storage medium with instructions stored therein, the instructions when executed causing a computing device to perform:
receiving one of HTML and XML content, the content having information inserted into it, all inserted information having identifiers;
searching the content for all information with the identifiers; and
generating a HTTP header for the content, the generated HTTP header including the information located in the content.

18. The apparatus according to claim 17, wherein the content comprises at least one web page.

19. The apparatus according to claim 17, wherein the information comprises Internet cache control information.

20. The apparatus according to claim 17, wherein the identifiers comprise at least one of a Meta tag, label, tag, and a command.
